(19) United States
(12) Patent Application Publication
(10) Pub. No.: US 2014/0131158 A1
(43) Pub. Date: May 15, 2014

(54) Machine Assembly

(71) Applicant: Voith Patent GmbH, Heidenheim (DE)

(72) Inventor: Martin Schabasser, Orbitzberg (AT)

(21) Appl. No.: 14/115,164

(22) PCT Filed: Oct. 19, 2012
(86) PCT No.: PCT/EP2012/070744

§ 371 Date: Jan. 22, 2014

(30) Foreign Application Priority Data
Nov. 7, 2011 (DE) 10 2011 117 766.7

(51) Int. Cl. F16D 21/00

(52) U.S. Cl. CPC F16D 21/00
USPC 192/48.5

(57) ABSTRACT

A machine assembly having a drive comprising an output shaft, a working machine which has a driveshaft, a coupling unit connected between the drive and the working machine. The coupling unit including a non-positive coupling and a positive coupling, where the positive coupling comprises at least two coupling elements, at least one of the coupling elements being rotatable relative to at least one of the remaining coupling elements of the non-positive and/or positive coupling by a specified angular range, and a switch which switches from the non-positive coupling to the positive coupling when a target rotational speed or a specified transmitted torque is achieved.

The present invention concerns a machine assembly with a drive unit and a working machine.

In the context of the invention, the drive unit can be a combustion engine or an electric motor or to be more accurate a turbine such as a water or a gas turbine, whereas conversely the working machine is a generator or a compressor. We are dealing here with very high performances, which in the order of magnitude of up to several thousand megawatts and above. Due to these extreme performances the machine assembly also features extraordinarily high rotating masses, which may inherently lead to particular problems.

A generic machine assembly must meet the highest standards. First of all, the working machine must be started up in such a way that the drive unit is not overloaded. Secondly, the working machine must run up to such a rotational speed which is identical to the rotational speed of the drive unit. In other words, both machines must run synchronously relative to one another.

Once synchronous run has been established, there must be a direct mechanical driving connection between the drive unit and the working machine. Such a driving connection must be on the one hand durable and hence subjected to reduced wear and on the other hand the driving connection must operate extremely reliably to absolutely prevent, also in case of failure of few components of the machine assembly, any damage or even destruction of said components or of the whole machine assembly.

Although the well-known machine assemblies of different manufacturers are considered as fully-developed and operating reliably, they do not meet all these standards in a satisfactory manner.

The object of the invention is then to provide a machine assembly with a drive unit, a working machine and a transmission component connected between both of them, whereas the machine assembly is designed for extremely high performances and rotational speeds, with which the working machine can be started up reliably and for the drive unit carefully, whereas the drive unit and the working machine can be run up to synchronous rotational speeds. To do so, the driving connection must constantly operate reliably between the working machine and the drive unit with minimal wear, and to prevent any damage or even any destruction of said drive unit in case of failure of a component of the machine assembly. The machine assembly must be configured in particular more easily and more profitably.

The inventor has hence found a solution of the problem which meets all the partial objects above mentioned. To that end, a coupling unit is provided between the working machine and the drive unit as a transmission component, a coupling unit comprising a non-positive coupling and at least one positive coupling, which can be connected in such a way that it is changed over from the non-positive coupling to the positive coupling when a target rotational speed or a certain transmission torque has been achieved.

The working machine can be started up as follows:
1. The drive unit is then started, the working machine stops.
2. The non-positive coupling, which is designed as a friction coupling, is closed.
3. The working machine is run up by the drive unit due to the closed friction coupling, and still until synchronous operation with the drive unit.
4. The presence of the synchronous operation can additionally be detected by means of sensors. This is however not strictly necessary.
5. The positive coupling is then connected.

According to an embodiment, the positive coupling can be connected in the direction of the power transmission as seen parallel to the non-positive coupling. To do so, with the input and output shafts operating synchronously and after switching the positive coupling, the torque can be transmitted in two ways from the drive unit to the working machine, and indeed once over the non-positive coupling in one way and on the other hand via the positive coupling in one way. Both frictional flows of force also run parallel to one another.

The positive coupling serves in such a case for example in case of failure of the actuating force, which holds the non-positive coupling in its closed position, as a safety device. The positive coupling can hence be designed in terms of performance in such a way that it solely transmits the whole transmission torque from the drive unit to the working machine. Alternatively, the non-positive coupling as regards their transmittable performance can be designed in such a way that it transfers a smaller torque as the positive coupling, for example, an idle torque of the working machine. In such a case, the non-positive coupling can be used exclusively for establishing the synchronicity between the input and the output shaft and can be open, but need not necessarily be open thereafter. To open the positive coupling, the non-positive coupling can be closed again, to disengage from each other coupling elements of the closed positive coupling, which can be clamped against one another. After opening the positive coupling, the non-positive coupling can also be re-opened.

A switchable friction coupling such as a lamella coupling can be used as a non-positive coupling. A toothed coupling or a claw coupling can be used for instance as a (purely) positive, engageable coupling. Both couplings can also be purely mechanical couplings.

The invention should now be described using the accompanying figures.

The figures are as follows:

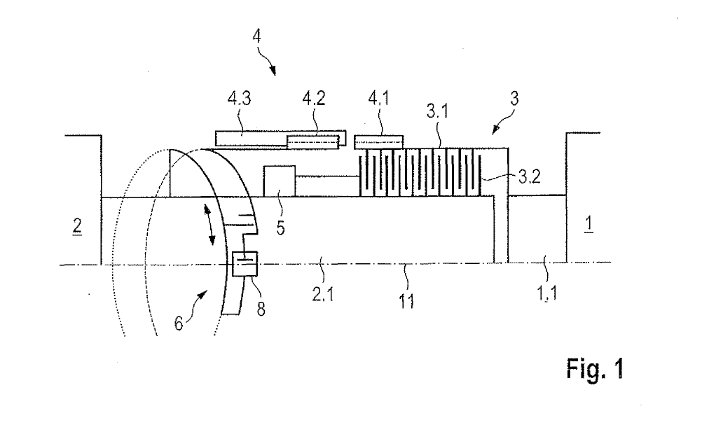

FIG. 1 shows a machine assembly in a diagrammatic illustration in accordance with a first alternative;

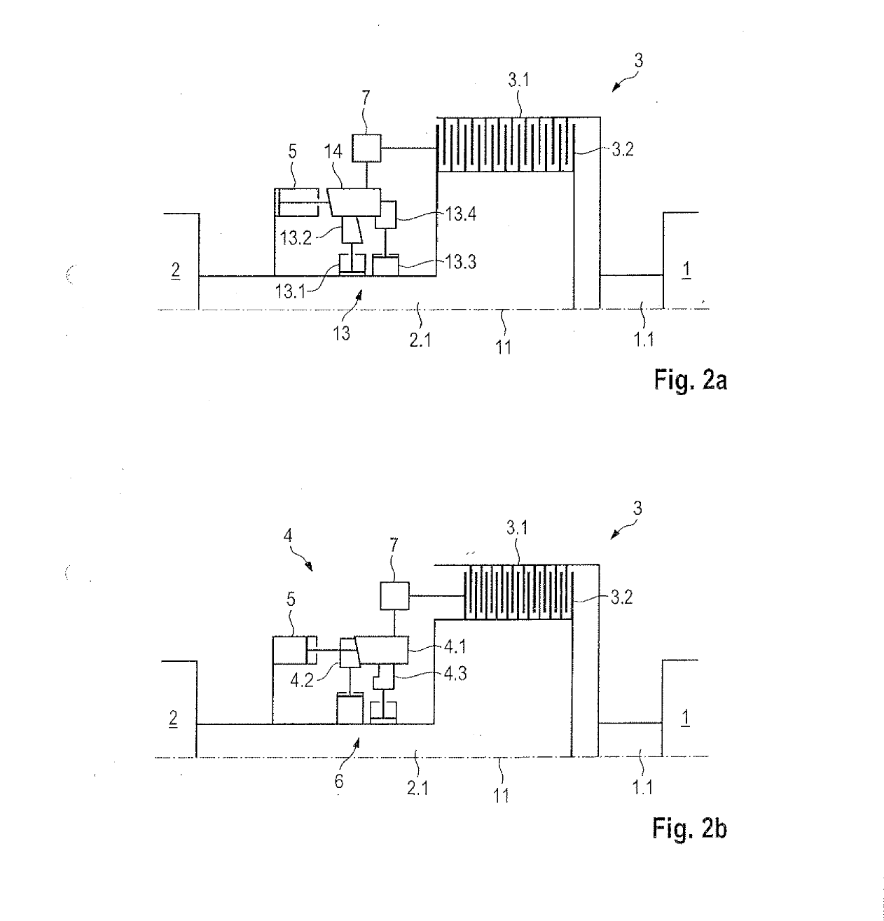

FIGS. 2a and 2b show a machine assembly in a diagrammatic illustration in accordance with a second alternative;

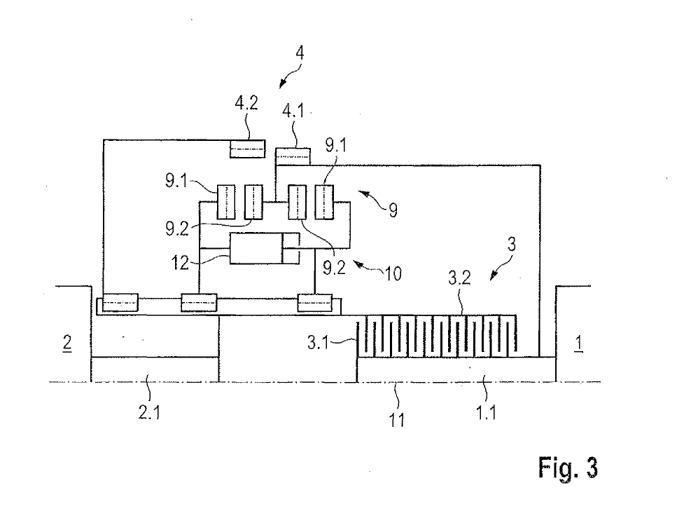

FIG. 3 shows a machine assembly in a diagrammatic illustration in accordance with a third alternative.

FIG. 1 shows a diagrammatic illustration of a machine assembly in accordance with a first alternative in a half-section through its rotational axis 11. The machine assembly comprises a drive unit 1 to do so, which drives an output shaft 1.1 into rotation. The drive shaft 1.1 hence rotates around the rotational axis 11.

A first mechanical coupling, designated here as a non-positive coupling, is provided for the purely mechanical coupling of the drive unit 1 with a working machine 2.

A non-illustrated transmission can be provided between the drive unit 1 and the non-positive coupling 3.

The coupling 3 comprises a first coupling element 3.1, which is designed rotationally rigidly with the output shaft 1.1. A second coupling element 3.2 is connected rotationally rigidly with a drive shaft 2.1 of the working machine 2.

The torque should be transmitted from the drive unit 1 to the working machine 2 with a closed coupling 3.

For actuating the coupling 3, a first is coupling device 5 hence provided, which is designed for instance as a piston-cylinder unit which can be operated with a pressure medium and here enables a relative axial movement of both coupling elements 3.1, 3.2 relative to one another by shifting said elements, so that both coupling elements 3.1, 3.2 can be brought in connection with another.

Moreover, a second mechanical coupling, here designated as a positive coupling 4, is provided. Said coupling comprises a third coupling element 4.1, which rotates together with the output shaft 1.1 as well as a fourth coupling element 4.2 rotating with the drive shaft 2.1.

In this instance, the third coupling element 4.1 is formed of the non-positive coupling 3, more precisely of its first coupling element 3.1 or is connected to such a coupling element. Both coupling elements 4.1, 4.2 can have a straight or oblique serration, in particular an external serration, and can be connected to a further coupling element 4.3 in such a way that a torque is transmitted from the third coupling element 4.1 to the fourth coupling element 4.2. To do so, the additional coupling element 4.3, as represented, can be designed for instance as a complementary serrated sliding sleeve with an internal serration. Both coupling elements 4.1, 4.2 can be brought into connection with one another by means of a second coupling device 6, which acts on the additional coupling element 4.3.

The first and second couplings 3, 4 are hence arranged parallel to one another in this instance in the direction of the power transmission from the drive unit 1 to the working machine 2 so that a torque can be transmitted in two ways, on the one hand via the non-positive coupling 3 and on the other hand via the positive coupling 4.

As designated in FIG. 1 by the double arrow, the second coupling element 4.2 together with the additional coupling element 4.3 is rotatable relatively by a specific angular range with respect to the remaining coupling elements 3.1, 4.1. A relative rotation of both coupling elements 4.2, 4.3 around the periphery takes place here by means of the second coupling device 6. Said coupling device is designed as a servomotor 8, which can be actuated for instance electrically or by means of a pressure medium.

In this instance, the servomotor 8 generates a rotational force acting in the peripheral or tangential direction to the rotational axis 11. Said angular range can be selected to be relatively small and may hence amount to once, twice, three times, four times or five times the division of the serration of the respective coupling elements 4.1, 4.2 or more.

A mechanical rotation constraint can be associated with the second coupling device 6 to limit the free relative rotation of the coupling elements 4.2 and 4.3 with respect to the coupling elements 3.1 and 4.2 to a certain angular range. In case of failure of the first coupling device 5, with the consequence that the actuating force, by means of which the coupling element 3.1 is pushed against the coupling element 3.2, drops, the coupling elements 4.2 and 4.3 are rotated with respect to one another or the drive shaft 2.1 with respect to the output shaft 1.1 along the periphery by the predetermined angular range. This operation continues until both coupling elements 4,2 and 4.3 strike against one another due to the rotation constraint. Hence, the torque is transmitted exclusively via the positive coupling 4. The working machine 2 or the drive unit 1 can now be shut down without damaging the machine assembly.

The coupling of the drive machine 2 to the drive unit 1 should now be described below using a preferred embodiment. The non-positive coupling 3 is closed after starting the drive unit 1, so that the working machine 2 runs up until it reaches a synchronous movement with the drive unit 1. The positive coupling 4 is closed once the synchronous movement has been established.

To do so, the fourth coupling element 4.2 by means of the second coupling element 6, here by means of the servomotor 8, is rotated so far in circumferential direction with respect to the third coupling element 4.1 so that the teeth of the internal serration of the additional coupling element 4.3 impact the gaps of the serration of the third coupling element 4.1. The coupling device 6 hence acts as a positioning device so as to position the corresponding tooth of the coupling element 4.2 on the corresponding gap of the coupling element 4.1.

In such a case, the additional coupling element 4.3 is pushed axially towards the third coupling element 4.1 by means of the second coupling element 6, to couple the coupling elements 4.1 and 4.2 together. Both couplings 3, 4 are now closed so that the torque is transmitted from the drive unit 1 to the working machine 2 in parallel via both couplings 3, 4.

The servomotor 8 can now in terms of the power to be transmitted, be sized in such a way that its positioning with respect to both coupling elements 4.2, 4.3 enables the latter to rotate without load. In such a case, the whole torque is transmitted by the non-positive coupling 3 and the servomotor 8 can be deactuated from the drive unit and output shaft once a synchronous rotational speed has been established.

If the servomotor 8 is designed as a hydraulic motor, the hydraulic supply to the servomotor 8 is connected pressureless. The result is that the whole transmittable power is exclusively transmitted by the non-positive coupling 3, whereas conversely the positive coupling 4 rotates therewith exclusively as a way of preventing failure of the non-positive coupling 3.

The positive-locking fit of the coupling 4 can only be released if no torque is transmitted from the drive unit 1 to the working machine 2 any longer.

Alternatively, the servomotor 8 can be sized in terms of performance in such a way that the whole torque can be transmitted via the positive coupling 4. In such a case, the non-positive coupling 3 opens (by actuation of the first coupling device 5) after coupling both coupling elements 4.1 and 4.2 of the positive coupling 4. Coupling elements 4.1, 4.2 can hence be rotated relative to one another under load. In such a case, the second coupling device 6 is not deactuated, so that the servomotor 8 is still impacted with hydraulic medium.

To release now the positive-locking fit between both coupling elements 4.1, 4.2 and to open the positive coupling 4, the non-positive coupling 3 is first of all closed and the second coupling 4 opens by deactivating of the second coupling device 6. Since now the whole torque is again transmitted via the non-positive coupling 3 the additional coupling element 4.3 can be removed relatively simply from the third coupling element 4.1 in axial direction.

FIGS. 2a and 2b show diagram illustrating a machine assembly in accordance with an alternative respectively in two positions of the non-positive coupling 3. FIG. 2a shows the non-positive coupling 3 in an open position, whereas conversely FIG. 2b shows said coupling in its closed position. As shown in FIG. 1, matching elements are indicated by the corresponding reference signs.

According to said embodiment, only the non-positive coupling 3 is provided whereas here both coupling elements 3.1, 3.2 can be shifted towards one another for closing the coupling 3 in axial direction and away from one another for opening said coupling.

A locking device 13 is associated with the coupling 3. The latter comprises a piston-cylinder unit 13.1, 13.3 respectively at whose piston end, a clamping body 13.2, 13.4 is arranged to be mobile with the piston here in radial direction of the coupling. The clamping bodies 13.2, 13.4 are hence designed in such a way that they can be clamped releasably in a non-positive or positive locking manner with an intermediate body 14, which is arranged on the coupling element 3.1.

The clamping bodies 13.2, 13.4 are used to prevent a movement of the coupling element 3.1 towards the open position of the coupling 3 when the intermediate body 14 is coupled, and hence both coupling halves 3.1, 3.2 of the coupling 3 from being released (unwillingly) from a closed position, as it is described more in detail below.

As illustrated in FIGS. 2a and 2b the clamping bodies 13.2, 13.4 can be actuated respectively separately by means of the corresponding piston-cylinder unit 13.1, 13.3. To do so, the clamping body 13,2 has such a coupling surface which forms a frictional contact with a complementary coupling surface of the intermediate body 14. The coupling surfaces complementary to one another can be in the form of cone or wedge. The slope of these surfaces as well as the friction values can be adapted to one another accordingly as regards the centrifugal force, to provide a holding torque for locking the coupling 3. In the present case, intermediate bodies 14 and clamping bodies 13.2 are wedge-shaped on their front sides facing each another. It goes without saying that such a configuration in which both bodies form together a positive-locking fit may be envisaged.

The clamping body 13.4 comprises in this instance a substantially L-shaped cross-section and enables to obtain a positive-locking fit together with the intermediate body 14.

The first coupling device 5 is non-actuated in the open position of the non-positive coupling 3 (FIG. 2a). Additionally, the piston-cylinder unit 13.3 is actuated in such a way that the clamping member 13A forms a positive-locking fit with the intermediate body 14. This positive-locking fit prevents the non-positive coupling 3 from being actuated inadvertently. In such a situation, the piston of the piston-cylinder unit 13.3 is blocked in axial direction from the clamping member 13.3 inserted radially. The clamping member 13.2 is situated conversely in its retracted position, in which it is released from the front-sided coupling surface of the intermediate body 14.

By actuating the coupling 3, here by operating the piston of the first coupling device 5 the second coupling element 3.2 is pushed axially on the first coupling element 3.1, so that the output shaft 1.1 and the drive shaft 2.1 are coupled together. The piston-cylinder unit 13.3 is depressurised in advance after which the clamping member 13.4 is retracted in radial direction and hence enables to push the piston of the first coupling device 5.

When the first mechanical coupling 3 is closed, the piston-cylinder unit 13.1 is actuated to brace the clamping member 13.2 with the intermediate body 14 and so to lock the piston of the coupling device 5. The clamping members 13.2, 13.4 again prevent in their closed position the first coupling 3 from opening by the springing back of the piston in case of failure of the first coupling device.

To prevent any inadvertent release of the clamping member 13.2 from the intermediate body 14 the friction values of both coupling surfaces are selected in such a way that the friction force occurring therebetween is greater than or equal to the actuating force of the first coupling device 5.

In this instance, a pretensioning device 7 is connected downstream of the coupling element 3.2 seen in the direction of the force from the first coupling device 5 to the non-positive coupling 3. Said pretensioning device is preferably used if the non-positive coupling 3 is designed as a lamella clutch. In such a case, the lamellae possess a very high axial rigidity. The piston stroke of the first coupling device 5 does not behave proportionally to the torque which can be transmitted from the lamella clutch due to the high axial rigidity. In other words it means that very small strokes of the piston of the coupling device 5 generate large modifications of the transmittable torque.

In an alternative, the high axial rigidity is compensated for by pretensioning the lamella clutch by means of the pretensioning device 7. A relief of the first coupling device 5 hence does not entail any reduction of the torque which can be transmitted from the lamella clutch. The pretensioning device 7 also enables to compensate for the thermal expansions which may crop in the lamella clutch, which otherwise might entail a reduction or an excessive increase of the contact pressing force and hence a modification of the torque which can be transmitted with the coupling 3.

FIG. 3 shows a diagrammatical illustration of a third alternative of the machine assembly according to the invention. Here again, matching components are designated with matching reference signs.

In the present case, the fourth coupling element 4.2 possesses an internal serration to be coupled in a positive locking manner with an external serration of the third coupling element 4.1 designed in complement. Said third coupling element is mounted to slide axially with respect to the output shaft 1.1 on the second coupling element 3.2 and hence to move the fourth coupling element 4.2 axially and can be coupled via a non-illustrated second coupling device here in axial direction with the fourth coupling element 4.2.

In a further embodiment, an additional positive coupling 9 is provided each comprising a pair of fifth coupling elements 9.1 as well as a pair of sixth coupling elements 9.2. The latter are in this instance rigidly connected with the third coupling element 4.1 of the positive coupling 4 or form a single-piece with the same.

The pair of fifth coupling elements 9.1 can be brought in connection with both coupling elements 9.2 via a third coupling device 10, so as to couple the output shaft 1.1 and the drive shaft 2.1 together in a torque-proof manner. The additional positive coupling 9 is hence arranged parallel to both other couplings 3.4.

The coupling surfaces of the coupling elements 9.1 and 9.2 arranged in pairs are opposite one another and here form serrations which are complementary to one another and can be brought in (exclusively) in an interlocking fit. The division of the serration can thus correspond to a multiple of the division of the serration between both coupling elements 4.1, 4.2.

The third coupling device 10 has a servomotor 12 which preferably can be actuated electrically or hydraulically, which by way of example can also be arranged as a piston-cylinder unit. To do so, respectively one of the fifth coupling elements 9.1 is connected to the cylinder and the other to the piston to generate simultaneous coupling of both coupling elements 9.1 with the complementary coupling elements 9.2 when pressurising the servomotor 12 and to release said coupling when deactivating the servomotor 12. Both coupling elements 9.1 are here again slidably mounted like the fourth coupling element 4.2 with respect to the output shaft 1.1 of the second coupling element 3.2.

Once synchronous run has been established between the output shaft 1.1 and the drive shaft 2.1, when the non-positive coupling 3 is closed, the additional coupling 9 is closed by actuating the third coupling device 10 with respect to the relative positioning of the third and fourth coupling halves 4.1 of the positive coupling 4. When latching the serrations of the coupling elements 9.1 and 9.2, said elements can be rotated relative to one another for instance by at least one division of the serration in the circumferential direction.

This relatively small rotation in the circumferential direction now enables to compensate for positional errors of the third and fourth coupling elements 4.1, 4.2. The procedure is as follows, the third coupling element 4.1 is also rotated relatively via the coupling process so that said coupling elements can coupled together practically without axial forces once the positive coupling has been closed.

### LIST OF REFERENCE SIGNS

1 Drive unit
1.1 Output shaft
2 Working machine
2.1 Drive shaft
3 First coupling
3.1 First coupling element
3.2 Second coupling element
4 Second coupling
4.1 Third coupling element
4.2 Fourth coupling element
4.3 Additional coupling element
5 First coupling device
6 Second coupling device
7 Pretensioning device
8 Servomotor
9 Third coupling
9.1 Fifth coupling element
9.2 Sixth coupling element
10 Third coupling device
11 Rotational axis
12 Servomotor
13 Locking device
13.1, 13.3 Piston-cylinder unit
13.2, 13.4 Clamping member
14 Intermediate body

1-14. (canceled)

15. A machine assembly comprising:
a drive unit, including an output shaft;
a working machine, which has a drive shaft;
a coupling unit connected between the drive unit and the working machine, comprising a non-positive coupling and a positive coupling, wherein the coupling unit comprises an additional positive coupling;
a switch, which switches from the non-positive coupling via the additional positive coupling to the positive coupling when a target rotational speed or a specific transmitted torque has been achieved;
wherein:
the non-positive coupling comprises a first and second coupling element, which selectively can be brought into driving connection with one another via a first coupling device;
the positive coupling comprises a third and fourth coupling element, which selectively can be brought into driving connection with one another via a second coupling device in order to couple the drive shaft and the output shaft with one another in a torque-proof manner, and the first mechanical coupling forms the third coupling element or is connected to said coupling element;
the additional positive coupling comprises a fifth and sixth coupling element which can he brought in connection with one another in a non-positive and/or positive locking manner via a third coupling device, so that the output shaft and the drive shaft can be coupled to each other in a torque-proof manner.

16. The machine assembly according to claim 15, wherein the fifth and sixth coupling element can be shifted with respect to one another axially together and can be brought into engagement together with the second coupling element or the output shaft in a non-positive and/or positive locking manner.

17. The machine assembly according to claim 15, wherein the fifth coupling element and the sixth coupling element have serrations which are complementary to one another, which can be brought into engagement with one another; and
the sixth coupling element is formed of the second coupling element or is connected to such a coupling element.

18. The machine assembly according to claim 16, wherein the fifth coupling element and the sixth coupling element have serrations which are complementary to one another, which can be brought into engagement with one another; and
the sixth coupling element is formed of the second coupling element or is connected to such a coupling element.

19. The machine assembly according to claim 15, wherein the fifth and sixth coupling elements are mounted axially with respect to the first coupling element or to the output shaft and can slide along the latter.

20. The machine assembly according to claim 16, wherein the fifth and sixth coupling elements are mounted axially with respect to the first coupling element or to the output shaft and can slide along the latter.

21. The machine assembly according to claim 17, wherein the fifth and sixth coupling elements are mounted axially with respect to the first coupling element or to the output shaft and can slide along the latter.

22. The machine assembly according to claim 18, wherein the fifth and sixth coupling elements are mounted axially with respect to the first coupling element or to the output shaft and can slide along the latter.

23. The machine assembly according to claim 15, wherein the first coupling element has a straight or oblique serration, which meshes with a serration, designed in complement, of the third coupling element.

24. The machine assembly according to claim 16, wherein the first coupling element has a straight or oblique serration, which meshes with a serration, designed in complement, of the third coupling element.

25. The machine assembly according to claim 17, wherein the first coupling element has a straight or oblique serration, which meshes with a serration, designed in complement, of the third coupling element.

26. The machine assembly according to claim 18, wherein the first coupling element has a straight or oblique serration, which meshes with a serration, designed in complement, of the third coupling element.

27. The machine assembly according to claim 19, wherein the first coupling element has a straight or oblique serration, which meshes with a serration, designed in complement, of the third coupling element.

28. The machine assembly according to claim 20, wherein the first coupling element has a straight or oblique serration, which meshes with a serration, designed in complement, of the third coupling element.

29. The machine assembly according to claim 21, wherein the first coupling element has a straight or oblique serration, which meshes with a serration, designed in complement, of the third coupling element.

30. The machine assembly according to claim 22, wherein the first coupling element has a straight or oblique serration, which meshes with a serration, designed in complement, of the third coupling element.

31. The machine assembly according to claim 15, wherein the non-positive coupling is designed to transmit a reduced torque, and the positive coupling to transmit a larger torque; or
the positive coupling is designed in terms of performance in such a way that it transmits substantially the same torque as the non-positive coupling.

32. The machine assembly according to claim 16, wherein the non-positive coupling is designed to transmit a reduced torque, and the positive coupling to transmit a larger torque; or
the positive coupling is designed in terms of performance in such a way that it transmits substantially the same torque as the non-positive coupling.

33. The machine assembly according to claim 17, wherein the non-positive coupling is designed to transmit a reduced torque, and the positive coupling to transmit a larger torque; or
the positive coupling is designed in terms of performance in such a way that it transmits substantially the same torque as the non-positive coupling.

34. The machine assembly according to claim 18, wherein the non-positive coupling is designed to transmit a reduced torque, and the positive coupling to transmit a larger torque; or
the positive coupling is designed in terms of performance in such a way that it transmits substantially the same torque as the non-positive coupling.
